(19) United States
(12) Patent Application Publication
(10) Pub. No.: US 2026/0311219 A1
(43) Pub. Date: Oct. 8, 2026

(54) METHOD AND SYSTEM FOR NATIVE RENDERING OF ADVERTISEMENTS

(71) Applicant: JPMorgan Chase Bank, N.A., New York, NY (US)

(72) Inventors: Hongkun JIN, Frisco, TX (US); Hemanth NARAYANAN, Prosper, TX (US); Benjamin ALLGEIER, Frisco, TX (US); Sharmila BETTES, Columbus, OH (US)

(73) Assignee: JPMorgan Chase Bank, N.A., New York, NY (US)

(21) Appl. No.: 19/556,856

(22) Filed: Mar. 4, 2026

Related U.S. Application Data
(60) Provisional application No. 63/784,690, filed on Apr. 7, 2025.

(51) Int. Cl. G06Q 30/0241; G06F 9/451

(52) U.S. Cl. CPC G06Q 30/0277; G06F 9/451

(57) ABSTRACT

Various methods and processes, apparatuses or systems, and media for rendering advertisements and other user interface files using a pre-defined format and structure in order to facilitate native display of the advertisements on mobile devices are disclosed. The method includes: transmitting, to a server, a request for an advertisement to be displayed on a mobile device; receiving, from the server in response to the request, a payload file that relates to the advertisement, the payload file having a first predetermined format that may include a JavaScript Object Notation (JSON) format; and using the payload file to natively render the advertisement for display on a screen of the mobile device.

### CROSS-REFERENCE TO RELATED APPLICATIONS

This application claims priority benefit from U.S. Provisional Application No. 63/784,690, filed on Apr. 7, 2025, in the United States Patent and Trademark Office, which is hereby incorporated by reference in its entirety.

### TECHNICAL FIELD

This disclosure relates to methods and apparatuses for rendering advertisements and other user interface files using a pre-defined format and structure in order to facilitate native display of the advertisements on mobile devices.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

In some conventional mobile applications (i.e., “mobile apps”), advertisement views for some mobile operating systems may be rendered using WebView templates within an operating system WebView container. Such an approach presents certain challenges. For example, this approach may be resource intensive. Utilizing WebView demands a relative high volume of system resources, including increased hardware memory and central processing unit (CPU) usage during user interface (UI) rendering. This can negatively impact app performance, leading to a poor user experience.

This approach may also cause security concerns. A JavaScript bridge may be necessary to facilitate interactions between a native app and a WebView template, thereby raising concerns about WebView security and potential vulnerabilities.

This approach may also cause a relatively high degree of development complexity. Each WebView template may require pre-building in order to ensure that the template accommodates complex layouts, components, and business logic. Such a process extends the development cycle and requires close collaboration with a mobile app team to address compatibility issues, which may be challenging and time-consuming.

Maintaining WebView templates may also be difficult due to an intricacy of a JavaScript bridge integration. When the templates are not managed by a mobile app team, debugging may be challenging, and deploying fixes may be problematic.

Release schedules may be misaligned. Changes to advertisement views may be tied to a web team’s schedule rather than a mobile app team’s release cycle. WebView templates may also offer poor support for native features on mobile devices such as dark mode, system font sizes, native components, and accessibility features. In addition, the loading phases of WebView and the complex JavaScript bridge integrations may result in less smooth display effects, leading to an unfriendly user experience.

Accordingly, there is a need for a mechanism for rendering advertisements and other user interface files using a pre-defined format and structure in order to facilitate native display of the advertisements on mobile devices.

### SUMMARY

The present disclosure, through one or more of its various aspects, embodiments, and/or specific features or sub-components, provides, among other features, various systems, servers, devices, methods, media, programs, and platforms for rendering advertisements and other user interface files using a pre-defined format and structure in order to facilitate native display of the advertisements on mobile devices.

According to an aspect of the present disclosure, a method for rendering an advertisement for display on a mobile device is provided. The method may be implemented by at least one processor. The method may include: transmitting, to a server, a request for the advertisement to be displayed on the mobile device; receiving, from the server in response to the request, a payload file that relates to the advertisement, the payload file having a first predetermined format; and using the payload file to natively render the advertisement for display on a screen of the mobile device.

The first predetermined format may include a JavaScript Object Notation (JSON) format.

The payload file may include a Uniform Resource Locator (URL) that corresponds to the advertisement, such that the URL may be used to fetch JSON data that relates to the advertisement.

The payload file may include: a view type property that relates to a layout of the advertisement with respect to the screen of the mobile device; and a view modifier property that relates to a plurality of attributes of the advertisement.

The layout of the advertisement may include at least one from among a first layout that includes a vertical stack of columns, a second layout that includes a horizontal stack of rows, a text, an image, a button, and a screen divider.

The plurality of attributes of the advertisement may include at least one from among a location, a background, a padding, a color, a theme, an action, and a typography.

The method may further include: determining whether the payload file includes information that relates to a first child view associated with the advertisement; and when the payload file is determined as including the information that relates to the first child view, using the payload file to natively render the first child view for display on the screen of the mobile device.

The first child view may include at least one second child view that reflects a recursive design concept.

The method may further include: receiving, from a user, a response to the advertisement; and based on the received response, displaying the first child view on the screen of the mobile device.

According to another embodiment, a computing apparatus for rendering an advertisement for display on a mobile device is provided. The computing apparatus includes a processor; a memory; and a communication interface coupled to each of the processor and the memory. The processor may be configured to: transmit, to a server via the communication interface, a request for the advertisement to be displayed on the mobile device; receive, from the server via the communication interface in response to the request, a payload file that relates to the advertisement, the payload file having a first predetermined format; and use the payload file to natively render the advertisement for display on a screen of the mobile device.

The first predetermined format may include a JavaScript Object Notation (JSON) format.

The payload file may include a Uniform Resource Locator (URL) that corresponds to the advertisement, such that the URL may be used to fetch JSON data that relates to the advertisement.

The payload file may include: a view type property that relates to a layout of the advertisement with respect to the screen of the mobile device; and a view modifier property that relates to a plurality of attributes of the advertisement.

The layout of the advertisement may include at least one from among a first layout that includes a vertical stack of columns, a second layout that includes a horizontal stack of rows, a text, an image, a button, and a screen divider.

The plurality of attributes of the advertisement may include at least one from among a location, a background, a padding, a color, a theme, an action, and a typography.

The processor may be further configured to: determine whether the payload file includes information that relates to a first child view associated with the advertisement; and when the payload file is determined as including the information that relates to the first child view, use the payload file to natively render the first child view for display on the screen of the mobile device.

The first child view may include at least one second child view that reflects a recursive design concept.

The processor may be further configured to: receive, from a user via the communication interface, a response to the advertisement; and based on the received response, display the first child view on the screen of the mobile device.

According to yet another embodiment, a non-transitory computer readable storage medium storing instructions for rendering an advertisement for display on a mobile device is provided. The storage medium includes a set of executable code which, when executed by a processor, may cause the processor to: transmit, to a server, a request for the advertisement to be displayed on the mobile device; receive, from the server in response to the request, a payload file that relates to the advertisement, the payload file having a first predetermined format; and use the payload file to natively render the advertisement for display on a screen of the mobile device.

The first predetermined format may include a JavaScript Object Notation (JSON) format.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a method for rendering advertisements and other user interface files using a pre-defined format and structure in order to facilitate native display of the advertisements on mobile devices, in accordance with an embodiment.

FIG. 2 illustrates an exemplary diagram of a network environment with a device for rendering advertisements and other user interface files using a pre-defined format and structure in order to facilitate native display of the advertisements on mobile devices, in accordance with an embodiment.

FIG. 3 illustrates a system diagram for implementing a method for rendering advertisements and other user interface files using a pre-defined format and structure in order to facilitate native display of the advertisements on mobile devices, in accordance with an embodiment.

FIG. 4 illustrates an exemplary flow chart of a process for rendering advertisements and other user interface files using a pre-defined format and structure in order to facilitate native display of the advertisements on mobile devices, in accordance with an embodiment.

FIG. 5 illustrates a data structure of an advertisement to be rendered on a mobile device, in accordance with an embodiment.

FIG. 6 illustrates an example of an advertisement rendered on a mobile device, in accordance with an embodiment.

FIG. 7 illustrates a data flow that corresponds to a method for rendering advertisements and other user interface files using a pre-defined format and structure in order to facilitate native display of the advertisements on mobile devices, in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

As disclosed herein, a system or method for rendering advertisements and other user interface files using a pre-defined format and structure in order to facilitate native display of the advertisements on mobile devices may improve interoperability, security, and efficiency by ensuring that for any particular advertisement, a payload file having a particular structure and format that encompasses layout, attributes, and components of the advertisement, and also ensuring that a lightweight and easy-to-transfer file is provided. In particular, the system or method may achieve these improvements by: transmitting, to a server, a request for an advertisement to be displayed on a mobile device; receiving, from the server in response to the request, a payload file that relates to the advertisement, the payload file having a first predetermined format, such as a JSON format, and the payload file also including a view type property that relates to a layout of the advertisement with respect to the screen of the mobile device and a view modifier property that relates to a plurality of attributes of the advertisement; and using the payload file to natively render the advertisement for display on a screen of the mobile device.

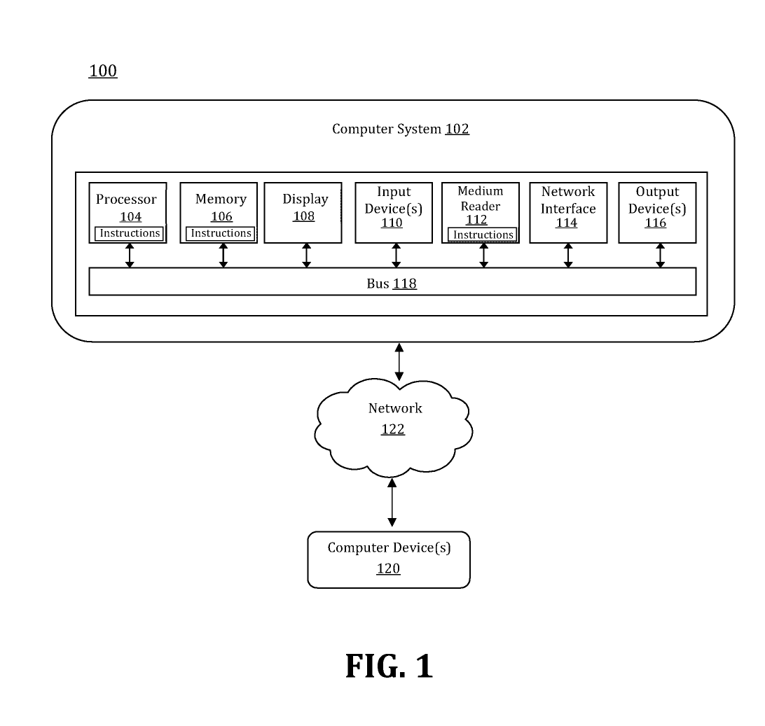

FIG. 1 is an exemplary system 100 for use in implementing a method for rendering advertisements and other user interface files using a pre-defined format and structure in order to facilitate native display of the advertisements on mobile devices, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such a cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the modules implemented by the system 100 may be platform, language, database, and cloud agnostic that may allow for consistent easy orchestration and passing of data through various components to output a desired result regardless of platform, browser, language, database, and cloud environment by writing programs accordingly. The configuration or data files, in some embodiments, may be written using JavaScript Object Notation (JSON), but the disclosure is not limited thereto. For example, the configuration or data files may easily be extended to other readable file formats such as Extensible Markup Language (XML), YAML Ain’t Markup Language (YAML), etc., or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionality as described herein, and a processor described herein may be used to support a virtual processing environment.

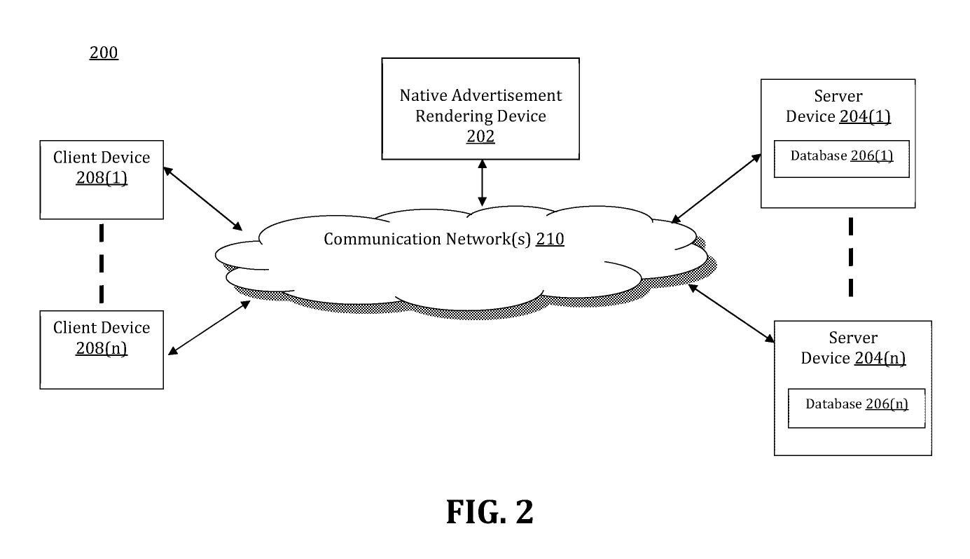

Referring to FIG. 2, a schematic of an exemplary network environment 200 for implementing a native advertisement rendering device (NARD) of the instant disclosure is illustrated.

In some embodiments, the above-described problems associated with conventional tools may be overcome by implementing an NARD 202 as illustrated in FIG. 2 that may be configured for implementing a method for rendering advertisements and other user interface files using a pre-defined format and structure in order to facilitate native display of the advertisements on mobile devices, but the disclosure is not limited thereto.

The NARD 202 may have one or more computer system 102s, as described with respect to FIG. 1, which in aggregate provide the necessary functions.

The NARD 202 may store one or more applications that can include executable instructions that, when executed by the NARD 202, cause the NARD 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the NARD 202 itself, may be located in virtual server(s) running in a cloud-based computing environment rather than being tied to one or more specific physical network computing devices. Also, the application(s) may be running in one or more virtual machines (VMs) executing on the NARD 202. Additionally, in one or more embodiments of this technology, virtual machine(s) running on the NARD 202 may be managed or supervised by a hypervisor.

In the network environment 200 of FIG. 2, the NARD 202 is coupled to a plurality of server devices 204(1)-204(n) that hosts a plurality of databases 206(1)-206(n), and also to a plurality of client devices 208(1)-208(n) via communication network(s) 210. A communication interface of the NARD 202, such as the network interface 114 of the computer system 102 of FIG. 1, operatively couples and communicates between the NARD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the NARD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The NARD 202 may be a standalone device or integrated with one or more other devices or apparatuses, such as one or more of the server devices 204(1)-204(n), for example. In one particular example, the NARD 202 may be hosted by one of the server devices 204(1)-204(n), and other arrangements are also possible. Moreover, one or more of the devices of the NARD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the NARD 202 via the communication network(s) 210 according to the HyperText Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store various types of data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the NARD 202 that may efficiently provide a platform for implementing a method for rendering advertisements and other user interface files using a pre-defined format and structure in order to facilitate native display of the advertisements on mobile devices, but the disclosure is not limited thereto.

The client devices 208(1)-208(n) may run interface applications, such as standard web browsers or standalone client applications, which may provide an interface to communicate with the DCCMD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the NARD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the NARD 202, the server devices 204(1)-204(n), or the client devices 208(1)-208(n), for example, may be configured to operate as virtual instances on the same physical machine. For example, one or more of the NARD 202, the server devices 204(1)-204(n), or the client devices 208(1)-208(n) may operate on the same physical device rather than as separate devices communicating through communication network(s) 210. Additionally, there may be more or fewer NARDs 202, server devices 204(1)-204(n), or client devices 208(1)-208(n) than illustrated in FIG. 2. In some embodiments, the NARD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

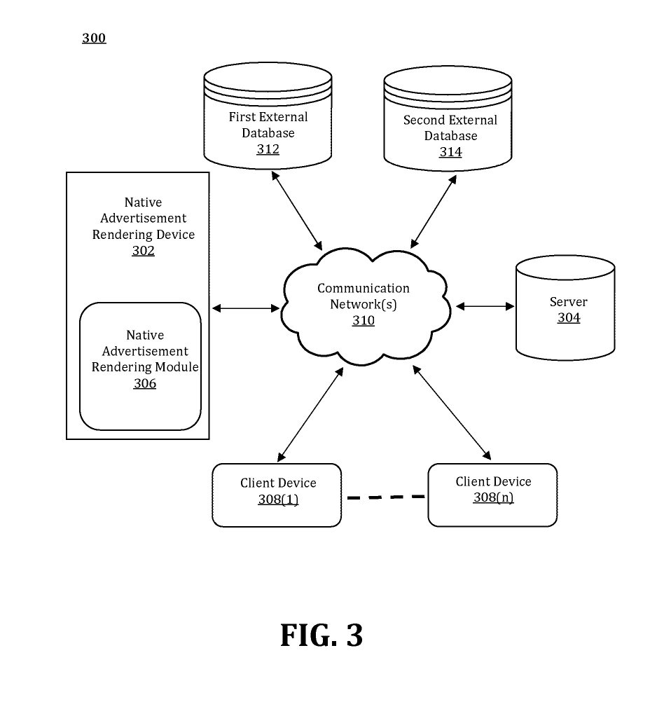

FIG. 3 illustrates a system diagram for implementing an NARD 302 having a native advertisement rendering module (NARM), in accordance with an embodiment.

As illustrated in FIG. 3, the system 300 may include a NARD 302 within which a NARM 306 is embedded, a server 304, a first external database 312, a second external database 314, a plurality of client devices 308(1) … 308(n), and a communication network 310.

In some embodiments, the NARD 302 including the NARM 306 may be connected to the server 304, and the database(s) 312 via the communication network 310. The NARD 302 may also be connected to the plurality of client devices 308(1) … 308(n) via the communication network 310, but the disclosure is not limited thereto.

In an embodiment, the NARD 302 is described and shown in FIG. 3 as including the NARM 306, although it may include other rules, policies, modules, databases, or applications, for example. In some embodiments, the first external database 312 and/or the second external database 314 may be configured to store ready to use modules written for each application programming interface (API) for all environments. Although only one database is illustrated in FIG. 3, the disclosure is not limited thereto. Any number of desired databases may be utilized for use in the disclosed invention herein. The databases 312, 314 may be a mainframe database, a log database that may produce programming for searching, monitoring, and analyzing machine-generated data via a web interface, etc., but the disclosure is not limited thereto.

In some embodiments, the NARM 306 may be configured to receive real-time feed of data from the plurality of client devices 308(1) … 308(n) and secondary sources via the communication network 310.

As may be described below, the NARM 306 may be configured to: transmit, to a server, a request for an advertisement to be displayed on a mobile device; receive, from the server in response to the request, a payload file that relates to the advertisement, the payload file having a first predetermined format, such as a JSON format, and the payload file also including a view type property that relates to a layout of the advertisement with respect to the screen of the mobile device and a view modifier property that relates to a plurality of attributes of the advertisement; and use the payload file to natively render the advertisement for display on a screen of the mobile device, but the disclosure is not limited thereto.

The plurality of client devices 308(1) … 308(n) are illustrated as being in communication with the NARD 302. In this regard, the plurality of client devices 308(1) … 308(n) may be “clients” (e.g., customers) of the NARD 302 and are described herein as such. Nevertheless, it is to be known and understood that the plurality of client devices 308(1) … 308(n) need not necessarily be “clients” of the NARD 302, or any entity described in association therewith herein. Any additional or alternative relationship may exist between either or both of the plurality of client devices 308(1) … 308(n) and the NARD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) … 308(n) may communicate with the NARD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The NARD 302 may be the same or similar to the NARD 202 as described with respect to FIG. 2, including any features or combination of features described with respect thereto.

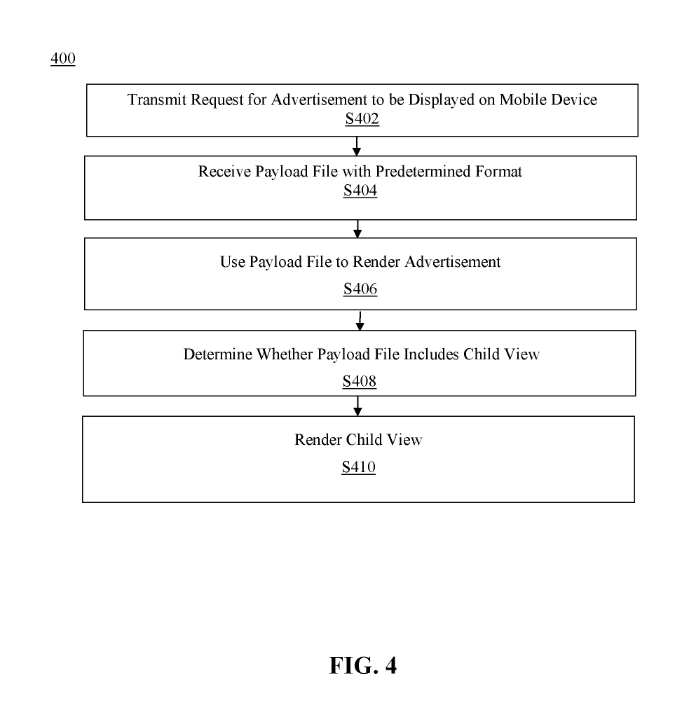

FIG. 4 illustrates an exemplary flow chart of a process 400 implemented by the NARM 306 of FIG. 3 for enablement of a system and a method for rendering advertisements and other user interface files using a pre-defined format and structure in order to facilitate native display of the advertisements on mobile devices, in accordance with an embodiment. It may be appreciated that the illustrated process 400 and associated steps may be performed in a different order, with illustrated steps omitted, with additional steps added, or with a combination of reordered, combined, omitted, or additional steps.

As illustrated in FIG. 4, at step S402, the process 400 may include transmitting, to a server, a request for an advertisement that is intended for display on a mobile device, such as, for example, a smart phone. Then, at step S404, the process 400 may include receiving a payload file that relates to the requested advertisement from the server. In an embodiment, the payload file may have a predetermined file format, such as, for example, a JavaScript Object Notation (JSON) format.

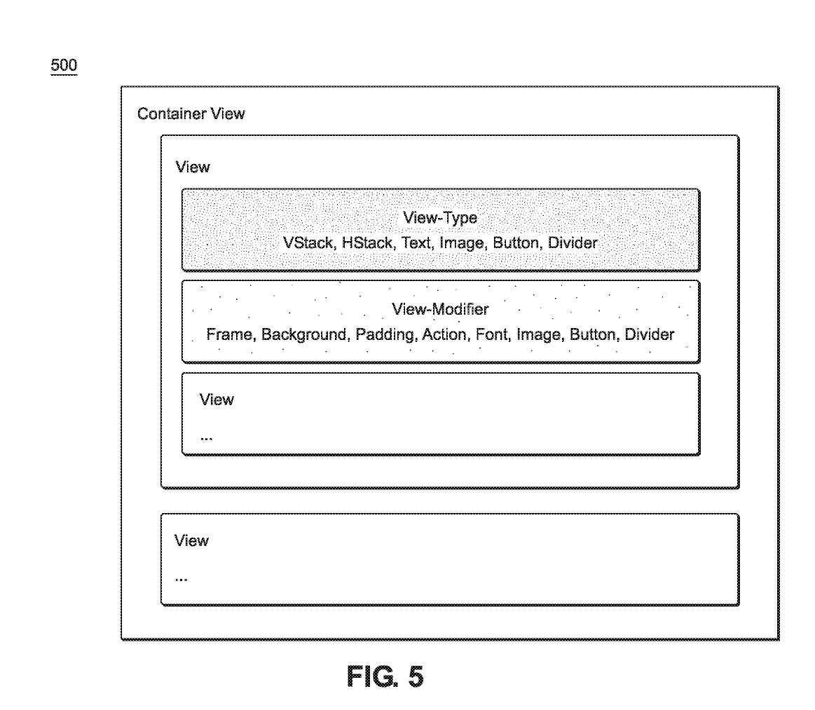

FIG. 5 illustrates a data structure 500 of an advertisement to be rendered on a mobile device, in accordance with an embodiment. As illustrated in FIG. 5, in an embodiment, the payload file may include a view type property that relates to a layout of the advertisement with respect to a screen of the mobile device on which the advertisement is to be displayed. The layout of the advertisement may include any one of more of a first layout that includes a vertical stack of columns, a second layout that includes a horizontal stack of rows, a text layout, an image, a button, and/or a screen divider. However, the present inventive concept is not limited thereto, and the layout of the advertisement may include any type of layout that is suitable for displaying the advertisement on the screen of the mobile device.

Referring again to FIG. 5, in an embodiment, the payload file may also include a view modifier property that relates to a set of attributes of the advertisement. For example, the set of attributes may include any one or more of a location, a background, a padding, a color, a theme, and action, and/or a typography. However, the present inventive concept is not limited thereto, and the set of attributes may include any type of attribute that is suitable for the display of the advertisement on the screen of the mobile device.

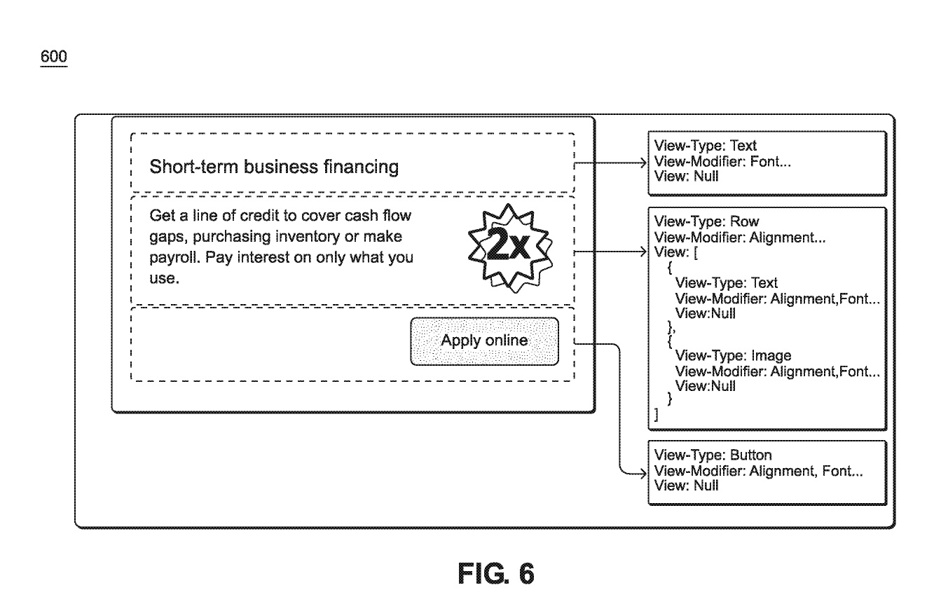

At step S406, the process 400 may include using the payload file to natively render the advertisement for display on the screen of the mobile device. FIG. 6 illustrates an example of an advertisement 600 rendered on a mobile device, in accordance with an embodiment. As illustrated in FIG. 6, in one example, a top portion of the advertisement 600 may include the words “Short-term business financing”, and as such, the view-type is text and the view-modifier refers to a font being used for the displaying of the text. In a middle portion of the advertisement 600, the view-type is a row that includes another view-type that is text and yet another view-type that is an image. The view-modifiers include an alignment of each of the three view-types, and also a font of the text and the image included in the middle portion. A bottom portion of the advertisement may include a view-type that is a clickable button and that includes view-modifiers that include an alignment of the button and a font of the text that appears within the button.

At step S408, the process 400 may include determining whether the payload file includes a child view. Then, at step S410, when a determination is made that the payload file includes a child view, the process 400 may include rendering the child view for display on the mobile device. In an embodiment, an advertisement may include one or more child views, and a child view may include additional child view(s), which reflects a recursive design concept. In an embodiment, a child view may be displayable based on a user’s response and/or interaction with the parent view of the advertisement.

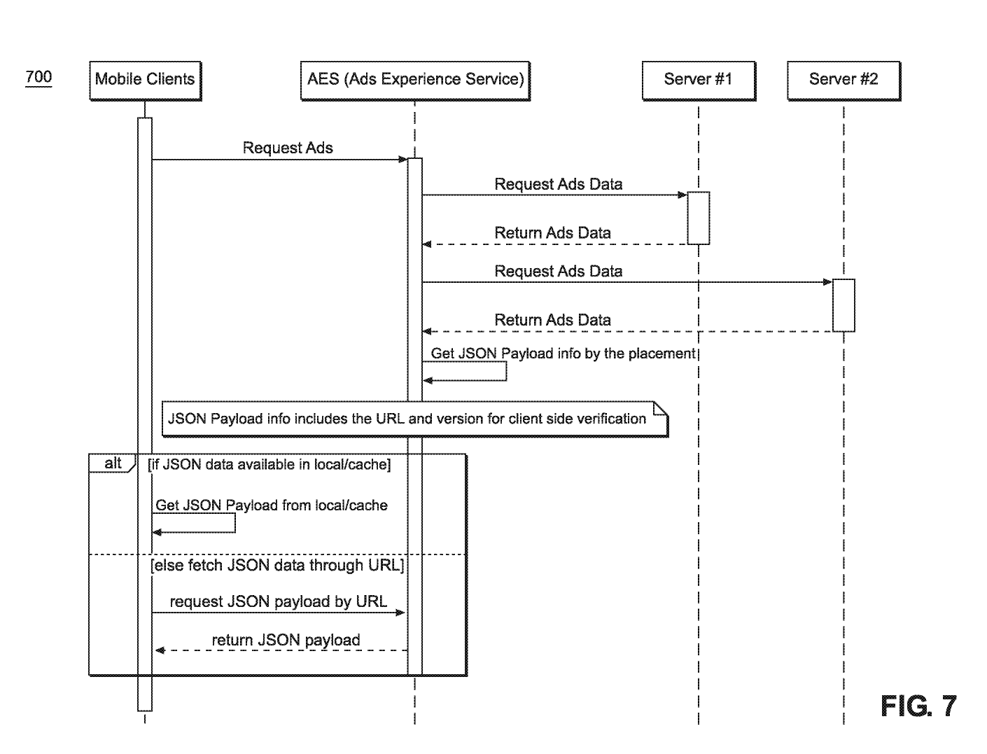

FIG. 7 illustrates a data flow 700 that corresponds to a method for rendering advertisements and other user interface files using a pre-defined format and structure in order to facilitate native display of the advertisements on mobile devices, in accordance with an embodiment. As shown in FIG. 7, the data flow 700 begins when a mobile client device transmits a request for one or more advertisements to a server, labeled herein as Ads Experience Service (AES). The AES server then requests data that relates to the requested advertisements from two sources, labeled herein as Server #1 and Server #2, and then the AES server receives responses that include the requested advertisement data. In an embodiment, Server #1 may correspond to a recommendation service that is configured for providing advertisement offer data to consumers, and Server #2 may correspond to an enterprise-based web-content management system that includes a wide array of features; but the present inventive concept is not limited thereto, and Server #1 and/or Server #2 may correspond to various other types of servers.

The AES server then uses the received data to generate a JSON payload file that corresponds to the requested advertisement(s). In an embodiment, the JSON payload file may include a Uniform Resource Locator (URL) that corresponds to the advertisement and version information that corresponds to the advertisement, in order to facilitate client side verification by the mobile client device.

As also shown in FIG. 7, in the event that the JSON payload file has previously been generated and is available in a local storage and/or a cache, the mobile client device may retrieve information relating to the JSON payload file from the local storage /cache. Alternatively, in the event that the JSON payload file has not yet been made available in the local storage/cache, the mobile client may use the URL to fetch JSON data relating to the advertisement(s). The mobile client may then transmit a request to the AES server to obtain the JSON payload file via the URL, and then receive the JSON payload file from the AES server.

In some embodiments as disclosed above in FIGS. 1-7, technical improvements effected by the instant disclosure may include a platform for rendering advertisements and other user interface files using a pre-defined format and structure in order to facilitate native display of the advertisements on mobile devices, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium may be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for rendering an advertisement for display on a mobile device, the method being implemented by at least one processor, the method comprising:
transmitting, to a server, a request for the advertisement to be displayed on the mobile device;
receiving, from the server in response to the request, a payload file that relates to the advertisement, the payload file having a first predetermined format; and
using the payload file to natively render the advertisement for display on a screen of the mobile device.

2. The method of claim 1, wherein the first predetermined format includes a JavaScript Object Notation (JSON) format.

3. The method of claim 2, wherein the payload file includes a Uniform Resource Locator (URL) that corresponds to the advertisement, such that the URL may be used to fetch JSON data that relates to the advertisement.

4. The method of claim 1, wherein the payload file includes: a view type property that relates to a layout of the advertisement with respect to the screen of the mobile device; and a view modifier property that relates to a plurality of attributes of the advertisement.

5. The method of claim 4, wherein the layout of the advertisement comprises at least one from among a first layout that includes a vertical stack of columns, a second layout that includes a horizontal stack of rows, a text, an image, a button, and a screen divider.

6. The method of claim 4, wherein the plurality of attributes of the advertisement includes at least one from among a location, a background, a padding, a color, a theme, an action, and a typography.

7. The method of claim 1, further comprising:
determining whether the payload file includes information that relates to a first child view associated with the advertisement; and
when the payload file is determined as including the information that relates to the first child view, using the payload file to natively render the first child view for display on the screen of the mobile device.

8. The method of claim 7, wherein the first child view includes at least one second child view that reflects a recursive design concept.

9. The method of claim 7, further comprising:
receiving, from a user, a response to the advertisement; and
based on the received response, displaying the first child view on the screen of the mobile device.

10. A computing apparatus for rendering an advertisement for display on a mobile device, the computing apparatus comprising:
a processor;
a memory; and
a communication interface coupled to each of the processor and the memory,
wherein the processor is configured to:
transmit, to a server via the communication interface, a request for the advertisement to be displayed on the mobile device;
receive, from the server via the communication interface in response to the request, a payload file that relates to the advertisement, the payload file having a first predetermined format; and
use the payload file to natively render the advertisement for display on a screen of the mobile device.

11. The computing apparatus of claim 10, wherein the first predetermined format includes a JavaScript Object Notation (JSON) format.

12. The computing apparatus of claim 11, wherein the payload file includes a Uniform Resource Locator (URL) that corresponds to the advertisement, such that the URL may be used to fetch JSON data that relates to the advertisement.

13. The computing apparatus of claim 10, wherein the payload file includes: a view type property that relates to a layout of the advertisement with respect to the screen of the mobile device; and a view modifier property that relates to a plurality of attributes of the advertisement.

14. The computing apparatus of claim 13, wherein the layout of the advertisement comprises at least one from among a first layout that includes a vertical stack of columns, a second layout that includes a horizontal stack of rows, a text, an image, a button, and a screen divider.

15. The computing apparatus of claim 13, wherein the plurality of attributes of the advertisement includes at least one from among a location, a background, a padding, a color, a theme, an action, and a typography.

16. The computing apparatus of claim 10, wherein the processor is further configured to:
determine whether the payload file includes information that relates to a first child view associated with the advertisement; and
when the payload file is determined as including the information that relates to the first child view, use the payload file to natively render the first child view for display on the screen of the mobile device.

17. The computing apparatus of claim 16, wherein the first child view includes at least one second child view that reflects a recursive design concept.

18. The computing apparatus of claim 16, wherein the processor is further configured to:
receive, from a user via the communication interface, a response to the advertisement; and
based on the received response, display the first child view on the screen of the mobile device.

19. A non-transitory computer readable storage medium storing instructions for rendering an advertisement for display on a mobile device, the storage medium comprising executable code which, when executed by a processor, causes the processor to:
transmit, to a server, a request for the advertisement to be displayed on the mobile device;
receive, from the server in response to the request, a payload file that relates to the advertisement, the payload file having a first predetermined format; and
use the payload file to natively render the advertisement for display on a screen of the mobile device.

20. The storage medium of claim 19, wherein the first predetermined format includes a JavaScript Object Notation (JSON) format.
